(19) United States
(12) Patent Application Publication
(10) Pub. No.: US 2026/0024344 A1
(43) Pub. Date: Jan. 22, 2026

(54) SYSTEM FOR ANOMALOUS TRAJECTORY DETECTION

(71) Applicant: i3 International Inc., Toronto (CA)

(72) Inventors: Jack Hoang, Toronto (CA); Andrew Hoang, Toronto (CA)

(73) Assignee: i3 International Inc., Toronto (CA)

(21) Appl. No.: 18/780,177

(22) Filed: Jul. 22, 2024

(51) Int. Cl. G06V 20/54; G06T 7/246; G06V 10/762; G06V 40/20; G08B 13/196

(52) U.S. Cl. CPC G06V 20/54; G06T 7/248; G06V 10/762; G06V 40/20; G08B 13/19608; G06T 2207/30196; G06T 2207/30236; G06T 2207/30241; G06V 2201/08

(57) ABSTRACT

A system for identifying anomalous movement of objects within an environment where the objects exhibit predictable traffic patterns. Each object has one or more visible features. The system includes one or more cameras positioned to capture images of the objects within the environment and a computing system. The computer system includes one or more processors and is configured to use a trained machine learning model to detect at least one of the one or more visible features of each object in the images and to track trajectories of the objects in the environment as they move within the environment. For each of the object trajectories, the system determines whether the trajectory is anomalous. When one of the trajectories is determined to be anomalous, an alarm is triggered.

### FILED OF THE INVENTION

The present invention relates generally to systems for tracking objects, and more particularly to systems for tracking objects and identifying anomalous trajectories of those objects.

### BACKGROUND OF THE INVENTION

Modern retail models are relying more on frictionless self-checkouts as a replacement for traditional cashier-staffed checkouts. Additionally, more advanced self-serve and self-checkout retail models have been proposed in recent years that rely on unmanned automation and robotics. Although loss prevention has always been a concern for retailers, this is becoming a more significant issue for retailers that are replacing cashier-staffed retail models with automated models in brick-and-mortar stores.

Retailers can leverage object detection, motion analysis and digital sensors to support loss prevention. By combining this technology with computer vision and machine learning, retailers can implement store monitoring systems that reduce product losses in near real-time.

### SUMMARY OF THE INVENTION

The invention is a system for identifying anomalous movement of objects, such as people and vehicles, within an environment, such as a retail establishment, where the objects exhibit predictable traffic patterns. Each object, such as a person, has one or more visible features, such as the head of the person.

The system employs one or more cameras positioned to capture images of the objects within the environment and a computing system comprising one or more computer processors which receives images/video data from the cameras. The system uses a trained machine learning model to detect at least one feature of each object in the images and to track trajectories of the objects in the environment as they move within the environment. For each of the object trajectories, the system determines whether the trajectory is anomalous. When one of the trajectories is determined to be anomalous, the system triggers an alarm, such as a sound played through a speaker or a visible indication on a display device.

Environments may include parking areas, car dealerships, prisons and prison yards.

The trajectory of one of the objects may be determined to be anomalous by clustering the trajectories of the objects based on spatial or temporal similarity, wherein the similarity of trajectories is determined using a TRAjectory CLUStering (TRACLUS) algorithm.

Each trajectory may be divided into a line segment group using the minimum description length (MDL) principle. The system may use a density-based line segment clustering algorithm, which includes measures of both direction and distance between trajectories. The line segments close to each other according to the distance measure may be grouped into clusters, and a representative trajectory may be generated for each cluster, wherein the representative trajectories are used to identify anomalous trajectories.

The trajectory clustering algorithm may analyze patterns in the collected anomalous trajectories and use pattern trajectories to determine whether a new trajectory is an anomaly.

One of the features of each person may be the head of the person and the trajectory of each person may be tracked by tracking the movement of the head of the person.

The environment may be a sales floor of a retail establishment having one or more checkout stations and on or more exits, and the objects are then customers of the retail establishment. The cameras are preferably positioned and configured to capture images including the checkout stations and the exits of the retail store. The cameras are preferably located and configured to image all parts of the retail store where customers are allowed. The system may be further configured to determine from the images whether each customer has a shopping cart. Then, the trajectory of one of the customers may be determined to be anomalous only when the customer has a shopping cart. The trajectory of one of the customers may be determined to be anomalous when the customer exits the retail store without having transited though one of the checkout stations. The trajectory of one of the customers may determined to be anomalous when the customer is proximate to one of the exits the retail store without having transited through one of the checkout stations.

The system is preferably configured to evaluate the condition of each shopping cart, such as whether a cart is full, empty or partially loaded with goods. Customers who approach or pass through an exit without transitting though a checkout station and paying for goods with an empty cart may be simply returning the cart to the place they picked it up after deciding not to purchase anything. However, a customer with a full or partially loaded cart who approaches or passes through an exit without transitting though a checkout station and paying for goods would be considered anomalous and an alarm would be generated.

When a customer is seen to be anomalously leaving though, approaching, or having passed through an exit, the system preferably captures an image of the customer going through the exit or near the exit from a camera located outside or near the exit. The system would then display that image of the customer on a management or security display device, such as a computer monitor, in association with an alarm indicating that an anomalous event has occurred.

To represent the central axis of a cluster, we define the average direction vector. We add vectors instead of their direction vectors (i.e., unit vectors) and normalize the result. It is an excellent heuristic that gives the effect of a more extended vector that contributes more to the average direction vector. We compute the average direction vector over the vectors representing each line segment in the cluster. The clustering center of a point is usually a point, and the clustering result of a trajectory is a representative trajectory. We use a scanning method to find the usual trajectory of each cluster.

The trajectory in a retail store contains the movement rules of moving objects. The movement rules of objects can be discovered by trajectory clustering. Trajectory clustering is based on spatial or temporal similarity, dividing objects with similar behaviours into one category. The trajectory clustering algorithm can discover patterns from the collected anomaly trajectories and use pattern trajectories to determine whether the new trajectory is an anomaly.

Most cluster research mainly focuses on point data, such as K-means, OPTICS and STING. Only a few clustering algorithms pay attention to the multiple line segments. Point clustering is dividing points into numerous clusters according to a specific rule. Each cluster has its center point, and the sum of distances from each end to the center point is the smallest.

This is clearly different from the approach disclosed herein. The trajectory is a sequence of points with order and direction, and the clustering of trajectories will be complex.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is schematically illustrated example of an object tracking system of a retail store environment. In FIG. 1, a customer with a shopping cart full of merchandise is attempting to exit a store without passing through a checkout station and an anti-theft action is performed to prevent the theft of merchandise (e.g., an alarm is activated).

FIG. 2 is a top view of a retail store environment that shows the trajectory of separate customers being tracked by the system disclosed herein and the system observes an anomalous event when one of the trajectories is proximate to a store exit.

FIG. 3 is a modified version of FIG. 2 that includes a preidentified exception region that is designated within the system. In FIG. 3, the system will not observe an anomalous event if an object's trajectory passes through the exception region before being proximate to a store exit.

FIG. 4 depicts examples of five trajectories of an objects in an environment.

FIG. 5 shows points Pc₁-Pc₄ which are characteristic points and trajectory TRᵢ is divided into three segments: Pc₁Pc₂, Pc₂Pc₃ and Pc₃Pc₄.

FIG. 6 depicts calculation of the MDL cost.

FIG. 7 illustrates our approach to generating an expected trajectory

### DETAILED DESCRIPTION OF THE INVENTION

The invention disclosed herein relates to a system for tracking the movement of human forms, vehicles, and/or other object types using camera vision and machine learning techniques. An anomalous trajectory detection algorithm based on machine learning detection and tracking technology is used to recognize an anomalous case and trigger an alarm or otherwise provide an indication to a user that an anomaly has been detected. For example, a customer leaving a retail store without first transitting through a checkout station and paying for the goods that the customer has taken from the establishment, which may be in a shopping cart, may be considered by the system to be an anomaly and trigger an alarm. The alarm may be audible or may be presented on a management/security display device with an image, images or video depicting the anomalous behaviour. By triggering an anti-theft function in relation to anomalous trajectories, the system will alert a retailer to the anomaly for further inspection.

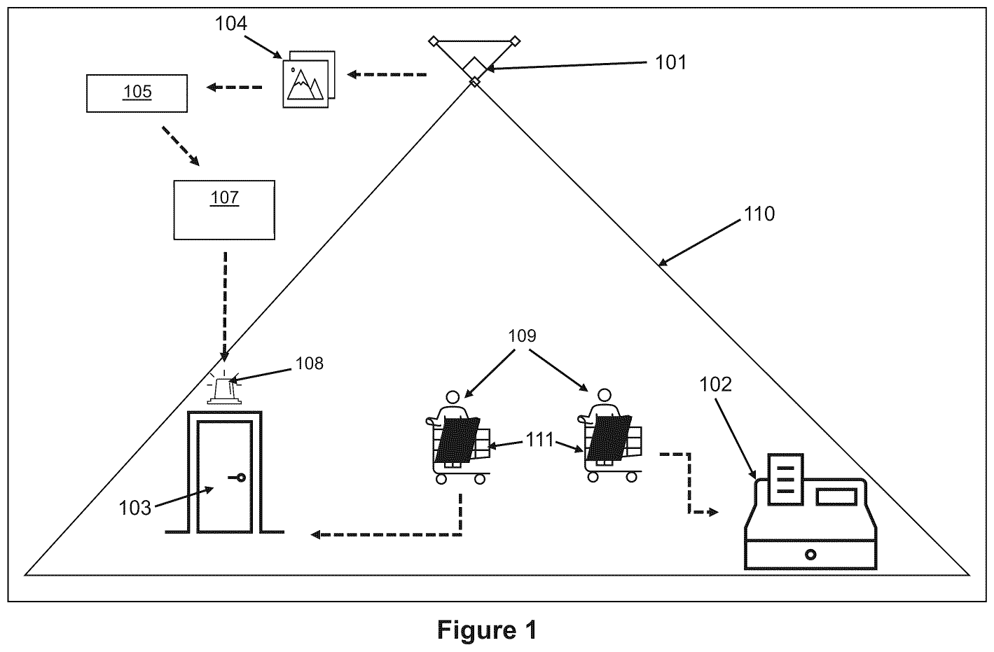

FIG. 1 schematically illustrates an example of a retail environment system. In FIG. 1, a camera unit 101 is positioned to image a region of the retail environment within its field of review (FOV) 110, including the checkout station 102 and exit to the store 103. The camera unit 101 includes a transceiver that transmits image sets 104 from the camera unit 101 to a central control unit (CCU) 105 or upload the image to the cloud, which uses machine learning and tracking technology to perform computer vision analysis of the image set 104 generated from camera 101. The CCU 105 can detect objects in the image set 104, including a customer 106 and a customer 109 within the FOV and consistently identify the customer 106 and customer 109 between consecutive images in the image set 104 to track the ongoing, separate trajectories of customer 106 and customer 109 as they travel through the FOV. The CCU 105 can be in communication with anti-theft functions 107 for the retail environment system, such as door alarm system 108, which can be triggered if the trajectory of either customer 106 or customer 109 is determined by the system to be an anomalous trajectory.

For a given environment, the system may be installed and initially given, for example, a week of observation to learn the trajectories of the movements in that environment. Then, identified trajectories that differ from the learned usual trajectories may be considered to be anomalous.

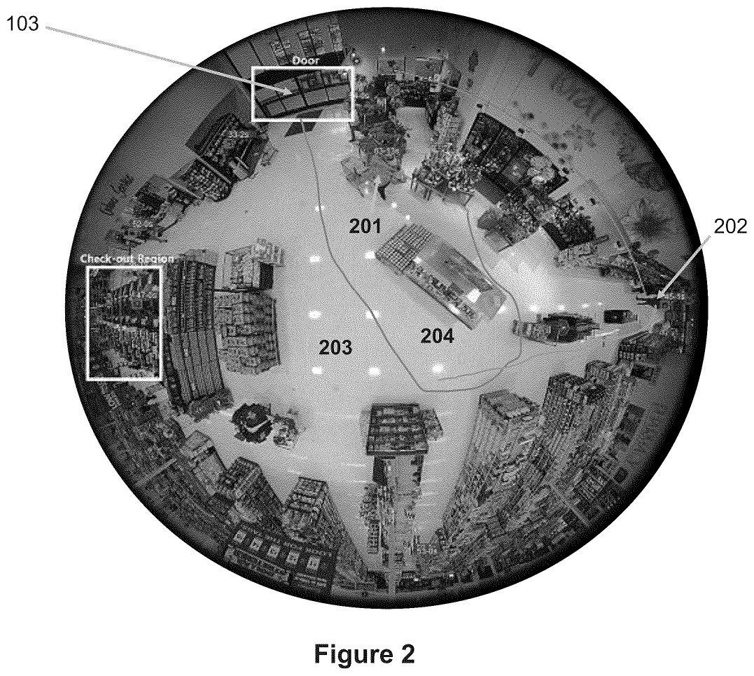

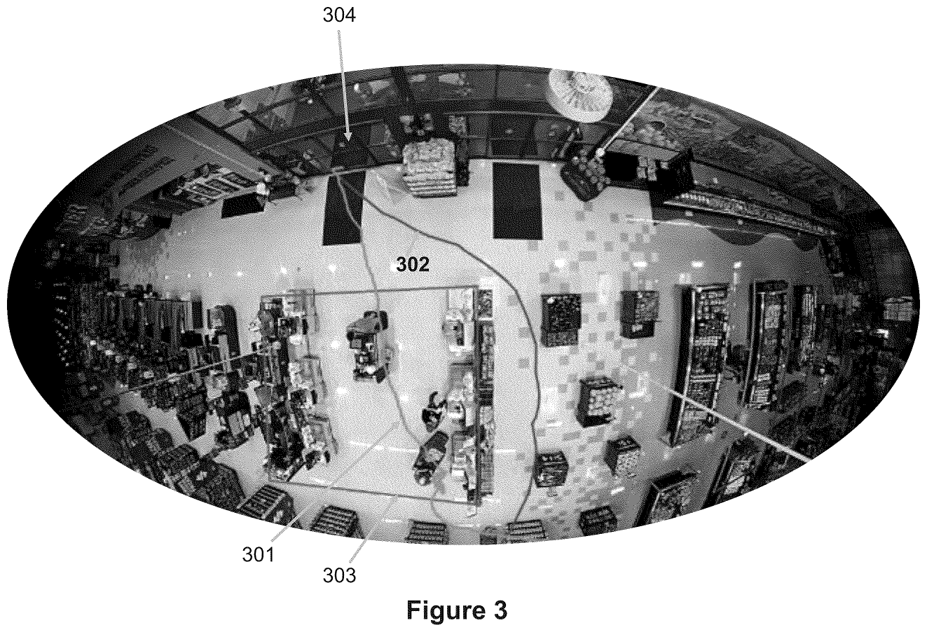

In some implementations in a retail establishment, the cameras 101 may be 360-degree fisheye cameras that are mounted to the retail store ceiling and capable of having a large FOV that captures one or more checkout stations and one or more store exits (see FIGS. 2 and 3). The camera 101 can be a grayscale or a color camera and may be mounted at different heights or configured to capture images from all parts of a retail store environment. The lens characteristics, human heads, distance and camera height are mapped to determine the spaces between each object to calculate the object movement, speed and distance and compensate for the subject's size (the further away from the center of the lens, the smaller the object and the slower speed) The camera's resolution is preferably at least 1080×720 pixels at 5 frames per second, which is the minimum that is desirable to track objects. The distance may be estimated using a fisheye distance algorithm as described below.

Referring to anti-theft function 107, this may engage different security actions depending on the resources available in the retail store environment. As seen in FIG. 1, anti-theft function 107 may trigger alarm 108 to notify the retailer of an anomalous event. In other embodiments, an anti-theft function may send a lock command to a shopping cart that is associated with a customer who is part of an anomalous event to prevent the shopping cart from leaving a store exit. As another example, an anti-theft function may send an alert to a mobile device that is carried by store personnel or communicate a warning that is displayed in-store to store personnel.

Referring to FIG. 1, for analyzing images in image set 104, CCU 105 can use machine learning technology to detect and track objects within image set 104 in real-time. Objects, such as customer 109, are tracked throughout each image of image set 104 with trajectories of the objects in each image being observed over the entire image set 104. By using a TRAjectory CLUStering (TRACLUS) algorithm, the CCU 105 can partition each trajectory into a set of line segments based on their moving characteristics, group line segments that are close to each other as belonging to a single cluster due to spatial and temporal similarities, then generate a representative trajectory for each set of trajectories. Each trajectory is then divided into line segment groups using the minimum methods.

A trajectory can belong to multiple clusters, and line segments of different trajectories can belong to the same cluster. A trajectory is partitioned into numerous line segments, and a clustering algorithm is performed over these line segments.

We aim to find the points where a trajectory's behaviour changes rapidly, which we refer to as characteristic points. It can be clearly seen in FIG. 5 that points Pc₁-Pc₄ are characteristic points and trajectory TRᵢ is divided into three segments: Pc₁Pc₂, Pc₂Pc₃ and Pc₃Pc₄.

When determining trajectory characteristic points, the disclosed method finds the optimal trade-off between accuracy and simplicity. It is the Minimum Description Length (MDL) principle, which is widely used in information theory. L(H) represents the sum of the lengths of all trajectory partitions, and L(D|H) represents the sum of the differences between a trajectory and its group of trajectory segments. We need their sum to be the smallest. MDLpar(pᵢ, pⱼ) represents the cost of MDL(=L(H)+L(D|H)) of the trajectory between pᵢ and pⱼ (i<j) when assuming that pᵢpⱼ is a line segment and pᵢ and pⱼ are the adjacent characteristic points. MDLnopar represents the cost related to the trajectory from pᵢ to pⱼ. We find all characteristic points, and the MDLpar of each line segment is local minimum. We believe that the sum of MDLpar for the entire trajectory is the smallest. In this way, we obtain a set of line segments composed of characteristic points.

The distance function is used in calculating MDL cost. It is the weighted sum of three kinds of distances. First, the perpendicular length measures the positional difference between line segments extracted from different trajectories. Second, the parallel space measures the positional difference between line segments extracted from the same trajectory. The parallel distance between two adjacent line segments is always zero. Third, the angle distance measures the directional difference between line segments.

The distance function is used in calculating MDL cost. It is the weighted sum of three kinds of distances. First, the perpendicular length measures the positional difference between line segments extracted from different trajectories. Second, the parallel space measures the positional difference between line segments extracted from the same trajectory. The parallel distance between two adjacent line segments is always zero. Third, the angle distance measures the directional difference between line segments. See FIG. 6.

We use a density-based line segment clustering algorithm to cluster these lines into several clusters. The algorithm consists of three steps.

The algorithm computes the E-neighborhood of each unclassified line segment L. The shape of an E-neighborhood in line segments is not a circle or a sphere. Instead, its form depends on data and will likely be an ellipse. If L is determined as a core line segment, the algorithm performs the second step to expand a cluster. The cluster currently contains only Nε(L).

The algorithm computes the density-connected set of a core line segment, computes the directly density-reachable line segments and adds them to the current cluster. If a newly added line segment is unclassified, it is added to the queue Q for more expansion since it might be a core line segment; otherwise, it is not added to Q since we already know it is not a core line segment.

The algorithm checks the trajectory cardinality of each cluster. The algorithm filters out the corresponding cluster if its trajectory cardinality is below the threshold.

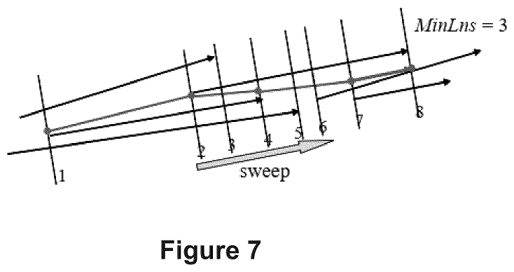

FIG. 7 illustrates our approach to generating an expected trajectory. The representative trajectory of a cluster describes the overall movement of the line segments that belong to the cluster. While sweeping a vertical line across line segments in the direction of the major axis of a cluster, we count the number of the line segments hitting the sweep line. This number changes only when the sweep line passes a starting or ending point. If this number is equal to or greater than the threshold (e.g. MinLn=3), we compute the average coordinate of those line segments with respect to the major axis and insert the average into the representative trajectory; otherwise, we skip the current point (e.g., the 5th and 6th positions in FIG. 7). If a previous point is located too close (e.g., the 3rd position in FIG. 7), we skip the current point to smooth the representative trajectory.

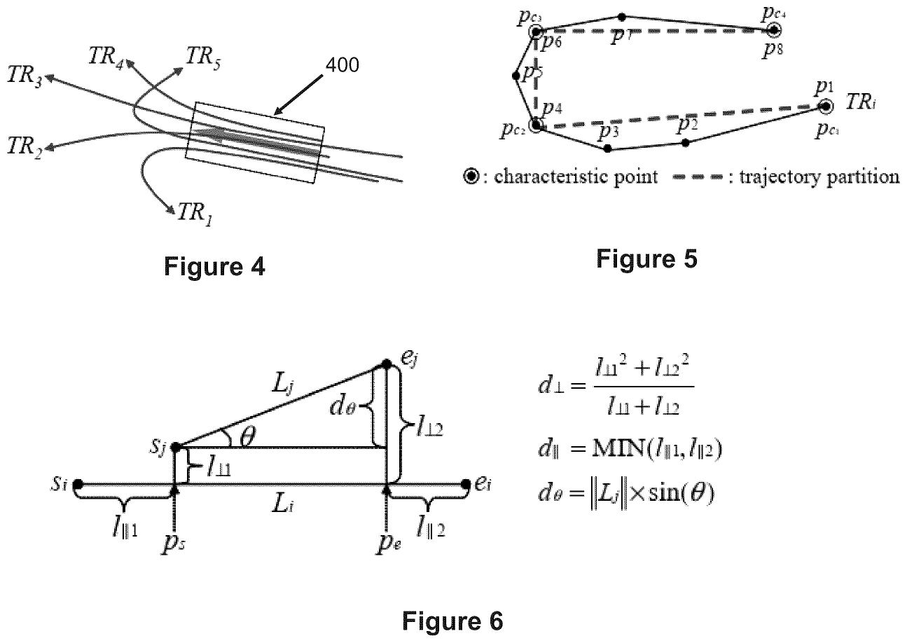

Prior art methods may use the entire trajectory to gather similar trajectories, but this can miss common sub-trajectories. Our approach divides each trajectory into a line segment group using the minimum description length principle (MDL). The five trajectories (TR₁-TR₅) shown in FIG. 4 are similar within the rectangle 400, but the parts outside are very different. The entire trajectories cannot be used to do useful clustering. Our approach divides each trajectory into a line segment group using the minimum description length (MDL) principle.

The algorithm used by the CCU manipulates and alters memory to accelerate the creation of images in a frame buffer intended for output to a display device, rendering the videos and executing multiple tasks simultaneously, making them suitable for handling complex computations in parallel.

FIG. 2 is an object tracking example of an open retail store environment, as would be observed by camera 101 in FIG. 1. In this embodiment, customers 201 and 202 are being tracked by the system as they traverse the retail store environment, with the customers' trajectories calculated by the system and depicted as line 203 for customer 201, and line 204 for customer 202, respectively. Using trajectories 203 and 204, the system is able to monitor the movement of customers 201 and 202 throughout the retail space. If either trajectory is proximate to exit 205, then the system will determine that an anomalous event has been observed and trigger an anti-theft function, such as sounding an alarm.

FIG. 3 is an object tracking example of an open retail store environment, as would be observed by camera 101 in FIG. 1. In this embodiment, customer trajectories 301 and 302 are being tracked across the retail store environment, and the system has preidentified exception region 303, which is a checkout station. When customer trajectory 301 enters this region before moving proximate to store exit 304 this will not be considered an anomalous event. However, the system will determine that an anomalous event has been observed when a trajectory does not first pass through the exception region 303 before moving proximate to store exit 304, as demonstrated by customer trajectory 302. Accordingly, the system will execute one or more loss-prevention actions, such as triggering an alarm, for customer trajectory 302, but not for customer trajectory 301.

Not all persons that leave a retail store without passing through a checkout station may require the initiating of anti-theft functions. For example, retail staff may push organized carts through exits or customers may enter a store and leave without any products. These are false alarms because they are categorized as anomalous events but may not necessarily require anti-theft functions. To increase the accuracy of the system and prevent such false alarms, an alternative embodiment may be applied wherein the system may detect and incorporate the trajectories of certain objects and use this combination to determine anomalous events. For example, in one embodiment, the system may use machine learning technology to detect a shopping cart in combination with a customer and only track customers when this combination exists. The system would then only observe an anomalous event when a customer trajectory in combination with a shopping cart trajectory are proximate to an exit without first travelling to an exception region.

Surveillance cameras often are ceiling mounted 360 degree fisheye cameras that provide a fisheye camera view. In order to estimate the distance between two objects in such a view, such as two people, is referred to as a fisheye distance algorithm. The video is analyzed by a convolutional neural network (CNN) method, which may identify each person's head area, and then identifies the head center position as the person's position.

Machine learning is a subset of artificial intelligence (AI) that focuses on developing algorithms that enable computers to learn from and make predictions or decisions based on data without being explicitly programmed to do so. The core of machine learning is to enable computers to learn patterns and relationships from large datasets and use that knowledge to make predictions or decisions about new data. There are various types of machine learning algorithms, including supervised, unsupervised, and reinforcement learning, each with its techniques and applications. Supervised learning algorithms learn from labelled training data, while unsupervised learning algorithms discover hidden patterns or structures in unlabeled data. Machine learning models require significant computational resources, especially when dealing with large datasets or complex models. A (graphics processing unit (GPU) accelerates Machine Learning. During the training phase of a machine learning model, tasks such as matrix multiplications, convolutions, and gradient calculations can be parallelized and offloaded to the GPU, significantly reducing training times. GPUs are particularly effective for deep learning models, which often involve complex neural network architectures with millions of parameters. The trajectory algorithm provides the computational power necessary to accelerate the training of machine learning models by leveraging their parallel processing capabilities, thereby enabling researchers and practitioners to tackle increasingly complex problems in science and technology.

The algorithm collects head samples from different angles and cameras (including fisheye cameras) and trains the CNN model to detect the head accurately. The head tracking algorithm can provide a stable trajectory for each person based on accurate head detection. Head tracking has much fewer occlusion issues than human body tracking. Primarily, the feature will be used with a fisheye camera on the ceiling, and from this angle, it will have fewer head occlusion issues. Another is to optimize the LCSS (Longest Common Subsequence) algorithm to compare the trajectory similarity, which can provide a stable and reliable estimation of the two trajectories' similarity. This algorithm can compare each person's trajectory with predefined anomaly trajectories and decide if the trajectory is an anomaly. Sometimes, a person carries bags, holds a baby or pushes a cart, so the algorithm is trained to detect/track them. Another algorithm is finding out if the shopping cart status (empty, merchandise or baby); this can make the feature more flexible and could detect exact anomaly trajectories in different scenarios.

### Example Embodiments

Embodiment 1: A system for identifying anomalous movement of a plurality of objects within an environment where the objects exhibit predictable traffic patterns, each object having one or more visible features, the system comprising: one or more cameras positioned to capture images of the objects within the environment; and a computing system comprising one or more processors, the computing system being configured to: use a trained machine learning model to detect at least one of the one or more visible features of each object in the images and to track trajectories of the objects in the environment as they move within the environment; for each of the object trajectories, determine whether the trajectory is anomalous; and when one of the trajectories is determined to be anomalous, trigger an alarm.

Embodiment 2: The system of any embodiment 1, wherein the trajectory of one of the objects is determined to be anomalous by clustering the trajectories of the objects based on spatial or temporal similarity, wherein similarity of trajectories is determined using a TRAjectory CLUStering (TRACLUS) algorithm.

Embodiment 3: The system of embodiment 2, wherein each trajectory is divided into a line segment group using the minimum description length (MDL) principle.

Embodiment 4: The system of embodiment 3, wherein the system uses a density-based line segment clustering algorithm, which includes measures of both direction and distance between trajectories.

Embodiment 5: The system of embodiment 4, wherein the line segments close to each other according to the distance measure are grouped into clusters, and a representative trajectory is generated for each cluster, wherein the representative trajectories are used to identify anomalous trajectories.

Embodiment 6: The system of any one of embodiments 2 to 5, wherein the trajectory clustering algorithm analyzes patterns in the collected anomaly trajectories and uses pattern trajectories to determine whether a new trajectory is an anomaly.

Embodiment 7: The system of any one of embodiments 1 to 6, wherein the objects are vehicles.

Embodiment 8: The system of any one of embodiments 1 to 6, wherein the objects are people.

Embodiment 9: The system of embodiment 8, wherein one of the features of each person is the head of the person and the trajectory of each person is tracked by tracking the movement of the head of the person.

Embodiment 10: The system of embodiment 8 or embodiment 9, wherein the environment is a sales floor of a retail establishment having checkout stations and exits, and the objects are customers of the retail establishment.

Embodiment 11: The system of embodiment 10, wherein the cameras are positioned and configured to capture images including the checkout stations and the exits of the retail store.

Embodiment 12: The system of embodiment 10 or embodiment 11, wherein the cameras are located and configured to image all parts of the retail store where customers are allowed.

Embodiment 13: The system of any one of embodiments 10 to 12, where the system is further configured to determine from the images whether each customer has a shopping cart.

Embodiment 14: The system of embodiment 13, wherein the trajectory of one of the customers is determined to be anomalous only when the customer has a shopping cart.

Embodiment 15: The system of any one of embodiments 10 to 14, wherein the trajectory of one of the customers is determined to be anomalous when the customer exits the retail store without having transited though one of the checkout stations.

Embodiment 16: The system of any one of embodiments 10 to 14, wherein the trajectory of one of the customers is determined to be anomalous when the customer is proximate to one of the exits the retail store without having transited through one of the checkout stations

Generally, a computer, computer/computing system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

It will be appreciated by a skilled person that, where a device is described with multiple components having different and distinct functions and functionalities, such a device further includes any different assignment of functions and functionalities between and among the components that produces a like result. It will be further appreciated that a single component, whether or not explicitly named, recited, or described, may have the functionality ascribed to different components in addition to or in lieu of the operation of those components. It will be further appreciated that the functionality of a single component may be performed by multiple other components, whether or not explicitly named, recited, or described, in addition to or in lieu of the operation of the single component.

It will be appreciated by a skilled person that, where a series of actions, options, steps, or states are described in the context of a method, such a method further includes any different order or permutation of the actions, options, steps, or states that produces a like result. It will be further appreciated that different actions, options, steps, or states of such a method may be performed simultaneously, sequentially, or otherwise.

The terms “about” and “approximately” can be used to include any numerical value that can vary without changing the basic function of that value. It is used to indicate that a specified value should not be construed as a precise or exact value, and that some variation either side of that value is contemplated and within the intended ambit of the disclosure. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

The scope of the claims that follow is not limited by the embodiments set forth in the description. The claims should be given the broadest purposive construction consistent with the description and figures as a whole.

What is claimed is:

1. A system for identifying anomalous movement of a plurality of objects within an environment where the objects exhibit predictable traffic patterns, each object having one or more visible features, the system comprising:
one or more cameras positioned to capture images of the objects within the environment; and
a computing system comprising one or more processors, the computing system being configured to:
use a trained machine learning model to detect at least one of the one or more visible features of each object in the images and to track trajectories of the objects in the environment as they move within the environment;
for each of the object trajectories, determine whether the trajectory is anomalous; and
when one of the trajectories is determined to be anomalous, trigger an alarm.

2. The system of claim 1, wherein the trajectory of one of the objects is determined to be anomalous by clustering the trajectories of the objects based on spatial or temporal similarity, wherein similarity of trajectories is determined using a TRAjectory CLUStering (TRACLUS) algorithm.

3. The system of claim 2, wherein each trajectory is divided into a line segment group using the minimum description length (MDL) principle.

4. The system of claim 3, wherein the system uses a density-based line segment clustering algorithm, which includes measures of both direction and distance between trajectories.

5. The system of claim 4, wherein the line segments close to each other according to the distance measure are grouped into clusters, and a representative trajectory is generated for each cluster, wherein the representative trajectories are used to identify anomalous trajectories.

6. The system of claim 2, wherein the trajectory clustering algorithm analyzes patterns in the collected anomaly trajectories and uses pattern trajectories to determine whether a new trajectory is an anomaly.

7. The system of claim 1, wherein the objects are vehicles.

8. The system of claim 1, wherein the objects are people.

9. The system of claim 8, wherein one of the features of each person is the head of the person and the trajectory of each person is tracked by tracking the movement of the head of the person.

10. The system of claim 8, wherein the environment is a sales floor of a retail establishment having checkout stations and exits, and the objects are customers of the retail establishment.

11. The system of claim 10, wherein the cameras are positioned and configured to capture images including the checkout stations and the exits of the retail store.

12. The system of claim 10, wherein the cameras are located and configured to image all parts of the retail store where customers are allowed.

13. The system of claim 10, where the system is further configured to determine from the images whether each customer has a shopping cart.

14. The system of claim 13, wherein the trajectory of one of the customers is determined to be anomalous only when the customer has a shopping cart.

15. The system of claim 10, wherein the trajectory of one of the customers is determined to be anomalous when the customer exits the retail store without having transited though one of the checkout stations.

16. The system of claim 10, wherein the trajectory of one of the customers is determined to be anomalous when the customer is proximate to one of the exits the retail store without having transited through one of the checkout stations.
